(19) United States
(12) Patent Application Publication
(10) Pub. No.: US 2021/0370531 A1
(43) Pub. Date: Dec. 2, 2021

(54) Pin, Toroidal Spring Socket, and High-Current Connector for a Robotic Device

(71) Applicant: ATI Industrial Automation, Inc., Apex, NC (US)

(72) Inventors: Dustin Christopher Simons, Raleigh, NC (US); William G. Berrocal, Holly Springs, NC (US)

(21) Appl. No.: 16/885,842

(22) Filed: May 28, 2020

(51) Int. Cl. B25J 19/00; B25J 15/04

(52) U.S. Cl. CPC B25J 19/0033; B25J 15/0408

(57) ABSTRACT

A pin and socket that form a connector to pass high current from a robotic device to a tool. The pin includes a separate non-conductive cap section and a conductive contact section along the length. The socket includes a body with an interior space and a body opening that leads into the interior space. A toroidal spring is positioned in the interior space of the body and includes an annular shape with a toroidal spring opening that aligns with the body opening. When fully inserted, the contact section of the pin contacts against the toroidal spring and the cap section is positioned in the interior space away from the toroidal spring.

### FIELD OF INVENTION

The present invention relates generally to an electrical connector for passing high current between two components and, more specifically, to an electrical connector with a pin and socket with a toroidal spring that engages with a pin.

### BACKGROUND

Robotic devices such as industrial robots and related automated equipment are equipped to connect with tools to perform a variety of different work functions. In many robotic manufacturing applications, it is cost-effective to utilize a robotic device that is or includes a relatively generic robot arm to accomplish a variety of tasks. For example, in an automotive manufacturing application, a robot arm may be connected to one or more first tools to perform a first set of tasks during one phase of production, and be connected to one or more second tools to perform a second set of tasks during a second phase of production.

In these applications, a tool changer is used to mate different tools to the robotic device. One half of the tool changer, called the master unit, is permanently affixed to the robotic device, such as to an end of a robot arm. The other half, called the tool unit, is affixed to each tool that the robotic device may utilize. When the robot arm positions the master unit adjacent a tool unit connected to a desired tool, a coupler is actuated that mechanically locks the master and tool units together, thus affixing the tool to the end of the robot arm. Operation of the robot arm, as well as many peripheral devices such as the master unit of a tool changer, is controlled by software executing on a robot controller.

Robotic tools require utilities, such as electrical current, for operation. The electrical current can be passed from the robotic device to the tools. This can include mating terminals positioned on each of the tool and the robotic device that mate together to pass the electrical current when the two are connected together. The mating terminals should be configured to provide for solid contact when the tool is connected to the robotic device. Further, the mating terminals should provide for a connection even if the tool is not properly aligned with the robotic device.

Further, pin and socket connectors can have high-wear issues if the pin is not accurately aligned with the socket prior to insertion. Designs should accommodate misalignment and still provide for engagement without causing excessive wear on the connector.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

One aspect is directed to a socket that engages with a pin of a connector to pass high current from a robotic device to a tool. The socket comprises a body comprising an enclosed interior space with a central section with the body further comprising a body opening that leads into the central section of the interior space. A toroidal spring is positioned in the interior space of the body and comprises an annular shape with a toroidal spring opening that aligns with the body opening. The toroidal spring extends around the central section. The toroidal spring comprises a helical body with a plurality of coils that each comprise an inner edge at the central section and that are exposed at the body opening and an outer edge positioned away from the central section and not exposed in the body opening.

In another aspect, the body comprises a bottom, a flange that extends around the body opening, and a lateral side that extends between the bottom and the flange.

In another aspect, the flange extends inward from the lateral side and with an inner edge of the flange defining the body opening.

In another aspect, the flange forms an overhang with the bottom, and the toroidal spring positioned in the overhang with the inner edges of the coils extending beyond the overhang and into the central section of the interior space.

In another aspect, the toroidal spring is in contact against each of the bottom, the lateral side, and the flange of the body.

In another aspect, each of the toroidal spring opening and the body opening have circular shapes.

In another aspect, the toroidal opening is coaxially aligned with the body opening.

In another aspect, a diameter of the opening of the toroidal spring is smaller than a diameter of the body opening.

In another aspect, the toroidal spring comprises a continuous helical coil comprising a plurality of coils.

One aspect is directed to a pin that engages with a socket of a connector to pass high current from a robotic device to a tool. The pin comprises a cap section positioned at a distal end of the pin. A contact section is positioned inward from the cap section along a length of the pin with the contact section electrically conductive. The cap section comprises a tapered shape that is narrower at the distal end and wider towards the contact section. The contact section comprises a fixed width.

In another aspect, the cap section is a separate piece that is connected to the contact section.

In another aspect, the cap section and the contact section are constructed from a single body and the cap section further comprises an electrically non-conductive coating on the conductive body.

In another aspect, the cap section is directly adjacent to the contact section and is electrically non-conductive.

In another aspect, each of the cap section and the contact section comprise circular sectional shapes.

One aspect is directed to a connector to pass high current from a robotic device to a tool. The connector comprises one or more pins and one or more sockets. The pins comprise: an elongated body with a distal end and a proximal end; a cap section positioned at the distal end with the cap section electrically non-conductive; and a contact section positioned along the body inward from the cap section with the contact section electrically conductive. The sockets comprise: a body that extends around and forms an interior space with the body further comprising a body opening that leads into the interior space; a toroidal spring positioned in the interior space of the body and contacting against the body with the toroidal spring comprising an enclosed opening with a toroidal spring opening that aligns with the body opening and with the toroidal spring comprising a helical body with a plurality of coils that each comprise an inner edge and an outer edge. The one or more pins are sized to fit within one of the sockets with the pins extending through the body opening and the toroidal spring opening and with the toroidal spring extending around and contacting against the contact section.

In another aspect, the cap section comprises a tapered shape that is narrower at the distal end and wider towards the contact section and the contact section comprises a constant width.

In another aspect, the interior space comprises an upper flange, lateral side, and bottom, with the toroidal spring positioned in the interior space and spaced away from the bottom.

In another aspect, the inner edges of the coils are exposed within the body opening and the outer edges of the coils are shielded by the body.

In another aspect, each the pin comprises a circular sectional shape and each of the toroidal spring opening and the body opening having circular shapes.

In another aspect, a diameter of the contact section of the pin is larger than a diameter of the toroidal spring opening.

In another aspect, the cap section comprises an electrically non-conductive coating.

In another aspect, the cap section of the pin is directly adjacent to the contact section.

One aspect is directed to a method of electrically connecting a pin to a socket to pass high current from a master assembly of a robotic device to a tool assembly. The method comprises: inserting the pin into the socket a first amount and into a body opening in the socket; inserting the pin into the socket an additional second amount and into an opening in a toroidal spring that is positioned in the socket and is coaxial with the body opening; contacting the pin against the toroidal spring; and with the pin contacting against the toroidal spring, passing high current between the socket and the pin.

In another aspect, the method further comprises inserting the pin into the opening in the toroidal spring and deforming the toroidal spring.

In another aspect, the method further comprises contacting the toroidal spring against a body of the socket while the pin is contacting against the toroidal spring and passing the high current through the body and into the toroidal spring.

In another aspect, the method further comprises inserting the pin into the opening in the toroidal spring and expanding a diameter of the opening.

In another aspect, contacting the pin against the toroidal spring comprises contacting the toroidal spring completely around a perimeter of the pin.

In another aspect, the method further comprises inserting the pin into the opening in the toroidal spring and forcing an outer edge of the toroidal spring against a lateral side of the socket.

In another aspect, the method further comprises contacting a conductive contact section of the pin against the toroidal spring and positioning a non-conductive cap section of the pin in the socket and away from the toroidal spring.

In another aspect, the method further comprises contacting a non-conductive tapered section of the pin against the toroidal spring prior to contacting a conductive section of the pin against the toroidal spring.

In another aspect, the method further comprises spacing a distal end of the pin away from the bottom of the socket when a conductive contact section of the pin contacts against the toroidal spring.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a perspective view of tool changer in a disengaged position with a master assembly positioned away from a tool assembly.

FIG. 2 is a schematic section view of a connector engaged with a pin inserted in a socket.

FIG. 3 is a plan view of a toroidal spring positioned in a socket.

FIG. 4 is a schematic section view cut along line IV-IV of FIG. 3.

FIG. 5 is a perspective view of a toroidal spring.

FIG. 6 is a plan view of a pin making electrical contact with a toroidal spring around a perimeter of the pin.

FIG. 7 is a schematic side view of a pin.

FIG. 8 is an end view of the pin.

FIG. 9 is a schematic section view of a pin positioned in an electrical socket and making electrical contact with a toroidal spring.

FIG. 10 is a flowchart diagram of a method of electrically connecting a pin to a socket to pass high current from a master assembly of a robotic device to a tool assembly.

### DETAILED DESCRIPTION

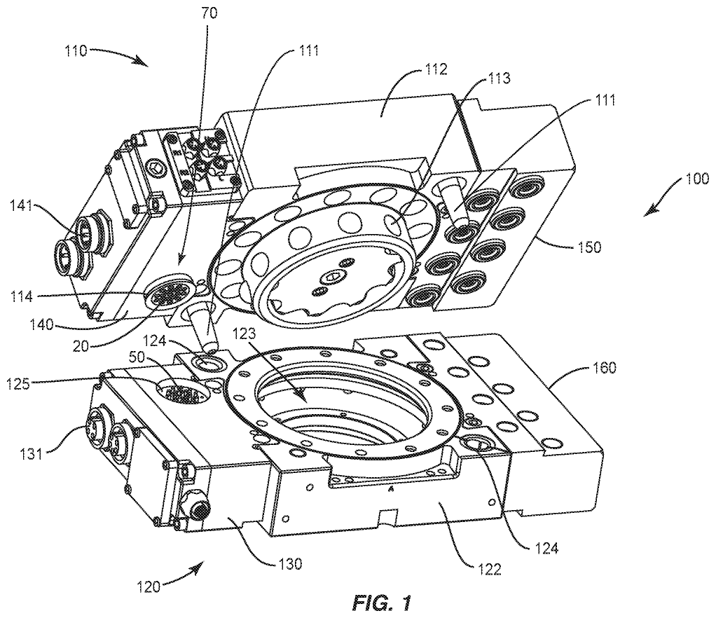

FIG. 1 depicts a robotic tool changer, indicated generally by the numeral 100. The robotic tool changer 10 comprises a master assembly 110 adapted to be connected to a robotic arm (not shown) and a tool assembly 120, adapted to be connected to a robotic tool (not shown). The robotic tool changer 100 allows users to selectively attach different tools to a robotic arm by selectively coupling and decoupling the master assembly 110 and the tool assembly 120. Alignment pins 111 on the master assembly 110 mate with alignment holes 124 on the tool assembly 120, to ensure proper alignment of the master and tool assemblies 110, 120 when coupled together.

The master assembly 110 includes a housing 112 and an annular collar 113 protruding therefrom and extending beyond the plane of the face of the housing 112. The tool assembly 120 includes a housing 122, with a circular chamber 123 formed therein. When the master and tool assemblies 110, 120 are engaged together, the collar 113 is inserted into the chamber 123. Further, locking features on the collar 113 and chamber 123 provide for locking together the master and tool assemblies 110, 120.

The tool changer 100 provides for the passing of various utilities, such as electrical power, pneumatic gas, fluids, data signals, and the like, between a robotic arm and a robotic tool. For example, FIG. 1 depicts a tool electrical signal module 130 affixed to the tool assembly 120. A master electrical signal module 140 is affixed to the master assembly 110. The modules 130, 140 include a connector 70 formed by one or more sockets 20 and corresponding pins 50. FIG. 1 includes the one or more sockets 20 on the master electrical signal module 140 and the pins 50 on the tool electrical signal module 130. This arrangement can be reversed with the one or more sockets 20 on the tool electrical signal module 130 and the one or more pins 50 on the master electrical signal module 140.

The tool electrical signal module 130 includes the one or more pins 50 connected internally to one or more connectors 131. The one or more pins 50 extend outward beyond a face 125. The master electrical signal module 140 includes sockets 20 adapted and disposed to mate with the pins 50. The sockets 20 are connected internally to one or more connectors 141. The one or more sockets 20 are positioned in a face 114. In one example, electrical power flows from the robot arm into the contacts 141 and sockets 20 and then to the pins 50 when the master and tool assemblies 110, 120 are coupled together. Electrical signals can also pass between the sockets 20 and pins 50 in either direction.

The tool changer 100 additionally includes a master pneumatic module 150 that engages with a tool pneumatic module 160 to allow for the passage of pressurized pneumatic fluid from a robotic arm to a robotic tool.

Features and structures of the master and tool assemblies 110, 120 are disclosed in U.S. Pat. Nos. 8,005,570, 8,132,816, and 8,209,840 which are each hereby incorporated by reference in their entireties.

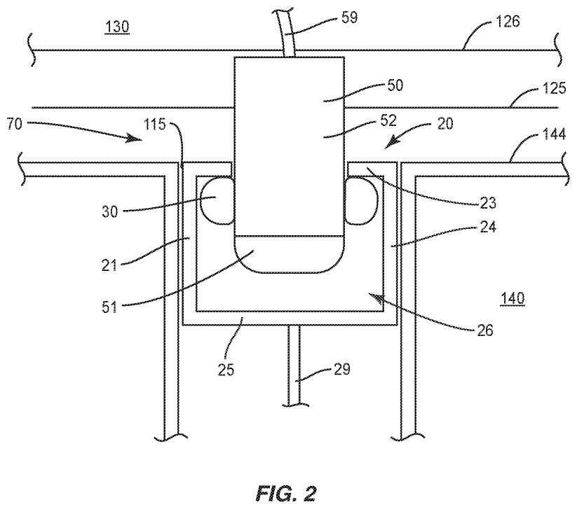

The connector 70 provides for physical contact between the one or more sockets 20 and pins 50 to pass high current from the master assembly 110 to the tool assembly 120. The connector 70 can include various numbers of sockets 20 and pins 50. FIG. 2 illustrates a portion or entirety of the sockets 20 and pins 50 of a connector 70 engaged together. The socket 20 includes a body 21 positioned in an opening in a face 114. A toroidal spring 30 extends around the socket 20 to engage around the perimeter of the pin 50. The pin 50 includes a cap 56 at a distal end and a conductive body 56. When the pin 50 is inserted into the socket 20, the toroidal spring 30 extends around and contacts the perimeter of the conductive body 56. Electrical current introduced through the connector 141 moves along lead 29 and to the socket 20. The electrical current passes to the pin 50 through contact with the toroidal spring 30 and through lead 59 and out through the connector 131 to the tool.

Each of the sockets 20 is configured to receive and contact against one of the pins 50. The contact provides an electrical path to pass current from the master assembly 110 to the tool assembly 120. In one example, the current that passes through the one or more sockets 20 and into the corresponding one or more pins 50 is high current sufficient to operate a tool (e.g., an arc welding tool). In one example, the high current to operate a tool is between about 1 amp and 5 amps. In another example, the high current is about 200 amps. In another example, the high current is between about 150-250 amps.

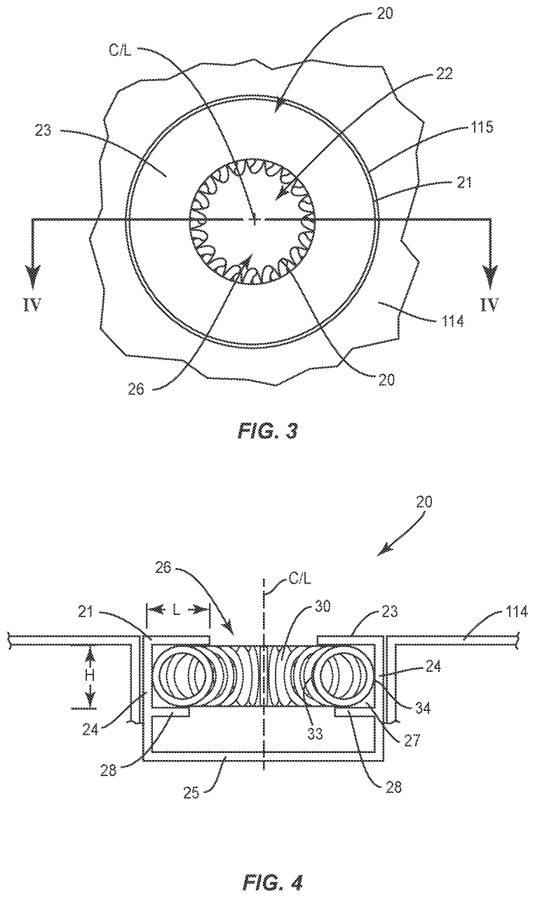

FIGS. 3 and 4 illustrate a socket 20 that is mounted within a receptacle 115 in the face 114 of the master assembly 140. The socket 20 includes a body 21 with a top flange 23, lateral side 24, and a bottom 25. The flange 23 is aligned with the face 114 and with the lateral side 24 and bottom 25 recessed inward from the face 114. The flange 23 extends inward from the lateral side 24 and forms an opening 22. The opening 22 leads into an interior space 26 that is formed between the flange 23, lateral side 24, and bottom 25. The interior space 26 includes an overhang or recessed section 27 positioned along the lateral side 24 underneath the flange 23. In one example, the bottom 25 and flange 23 each lie in planes that are parallel with one another and the lateral side 24 is perpendicular to the planes.

A toroidal spring 30 is positioned in the interior space 26 and functions as a contact between the pin 50 and the socket 20. A majority of the toroidal spring 30 is positioned in the recessed section 27 with a smaller section extending outward into the opening 22 and beyond the flange 23. This positioning exposes the toroidal spring 30 for contact with the pin 50. In one example, the opening 22 in the socket 20 is aligned coaxially with the opening 32 in the toroidal spring 30.

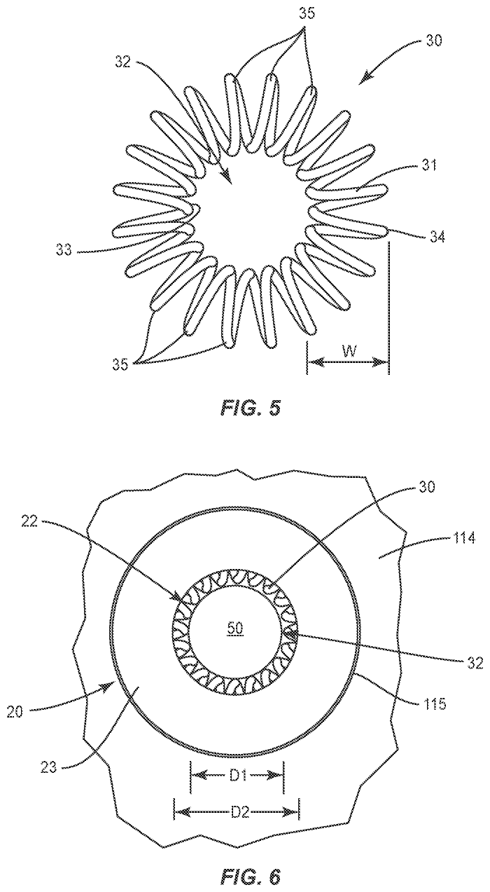

As illustrated in FIG. 5, the toroidal spring 30 includes a wire 31 with a helical shape that wraps around and forms a central opening 32. The wire 31 includes a circular sectional shape. The wire 31 is continuous around the central opening 32 with the helical shape forming a series of coils 35. Each of the coils 35 includes an inner edge 33 at the opening 32 and an outer edge 34 away from the opening 32. The toroidal spring 30 includes an annular shape that causes the inner edges 33 of each coil 35 to be closer together than the outer edges 34 of each coil 35. In one example as illustrated in FIG. 5, the inner edges 33 of the coils 35 are spaced apart. In another example, the inner edges 33 contact together.

The toroidal spring 30 can include various shapes and sizes. In one example as illustrated in FIG. 5, the toroidal spring 30 has a circular shape with a circular opening 32. The toroidal spring 30 and opening 32 can include other shapes, including but not limited to polygonal and oblong.

As illustrated in FIG. 5, the toroidal spring 30 includes a width W measured between the inner and outer edges 33, 34. This width W is greater than a length L of the flange 23. This sizing provides for the inner edges 33 to extend outward beyond the flange 23 and be exposed in the opening 22 with the outer edges 34 contacting against the lateral side 24. Further as illustrated in FIG. 6, the diameter D1 of the opening 32 in the toroidal spring 30 is smaller than the diameter D2 of the opening 22 in the body 21. This provides for the toroidal spring 30 to extend outward around the perimeter of the opening 22.

In one example, each of the coils 35 of the toroidal spring 30 includes a substantially circular sectional shape. Other examples include the coils 35 having non-circular shapes. The coils 35 can include the same shape to provide for uniform contact around the perimeter of the pin 50. In another example, the coils 35 include different sizes with a limited number of the coils 35 contacting against the pin 50 around the perimeter.

As illustrated in FIG. 4, the toroidal spring 30 includes a height H. The height H is smaller than the height of the interior space 26 measured between the flange 23 and bottom 25. This provides for the distal end of the pin 50 to be inserted into the interior space 26 beyond the toroidal spring 30. A shelf 28 extends inward from the lateral side 24 to position the toroidal spring 30 in the upper section of the interior space 26.

The toroidal spring 30 extends around the opening 22 of the socket 20. As illustrated in FIG. 6, this provides for the toroidal spring 30 to contact against the outer edge 51 of the pin 50 completely around its perimeter. This provides for passing high-current between the master assembly 110 and the tool assembly 120. In another example, the toroidal spring 30 does not extend completely around the opening 22.

In one example, the toroidal spring 30 is constructed from a coil spring. The coil spring is looped into a circle and the ends are connected together to form the continuous toroidal spring 30.

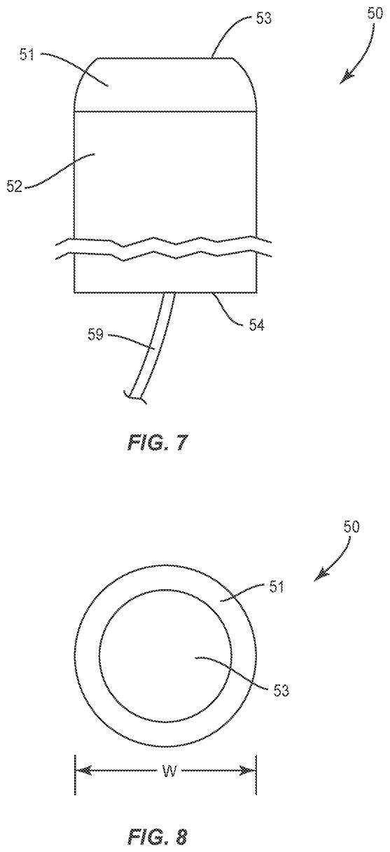

The pin 50 is sized to fit in the opening 32 in the spring 30 and contacts against the toroidal spring 30 and the perimeter. FIGS. 7 and 8 illustrate a pin 50 that extends between a distal end 53 and a proximal end 54. The length of the pin 50 measured between the ends 53, 54 can vary.

The pin 50 includes a cap section 51 at the distal end 53 and a contact section 52 inward from the cap section 51. The cap section 51 is constructed to facilitate insertion into the opening 32 in the spring 30. The cap section 51 includes a tapered shape that is narrower at the distal end 53 and larger at the contact section 52. The entire cap section 51 can be tapered, or just a limited section at the distal end 53 can be tapered. The cap section 51 is constructed from a low friction material to facilitate sliding and moving along the toroidal spring 30 during insertion and removal. Materials include but are not limited to plastic. In one example, the cap section 51 is a separate piece that is attached to the contact section 52. This can include the cap section 51 machined and added as an assembly to the contact section 52. In another example, the cap section 51 and contact section 52 is constructed as a unitary one-piece body and the cap section 51 further includes a low friction coating that is applied over body. In another example, the cap section is over-molded or ultrasonically welded onto the body. In one example, the cap section 51 is not tapered.

In one example, the cap section 51 is not electrically conductive. This is because the cap section 51 does not contact the toroidal spring 30 when the pin 50 is fully inserted into the socket 20 as illustrated in FIG. 2. In another example, the cap section 51 is electrically conductive but does not provide for the electrical contact as it is spaced away from the toroidal spring 30 when the pin 50 is inserted.

The contact section 52 is positioned inward from the cap section 51 and contacts against the toroidal spring 30 when the pin 50 is fully inserted into the socket 20. The contact section 52 is electrically conductive to allow the electrical current to pass during the connection.

The contact section 52 includes a constant width W along its length for uniform contact with the toroidal spring 30 when the pin 50 is inserted at different depths into the socket 20. The constant width W further provides for the toroidal spring 30 to contact the entire perimeter of the contact section 52. The contact section 52 can extend to the proximal end 54, or one or more additional sections can be located along the pin 50 between the contact section 52 and the proximal end 54.

The structure of the pin 50 facilitates insertion and still provides for electrical contact when the pin 50 is fully inserted in the socket 20. The cap section 51 offsets the wear to the pin 50 and socket 20 in situations in which the pin 50 is not fully aligned with the socket 20 during insertion (referred to as side-loading). The contact section 52 with the constant width W provides for electrical contact once the pin 50 is fully inserted into the socket 20.

In one example, the pin 50 includes a circular sectional shape.

Each of the contact section 52 of the pin 50, the toroidal spring 30, and the body 21 of the socket 21 are electrically conductive to provide for the electrical current to pass when the connector 70 is engaged. Conductive materials include but are not limited to copper, steel, aluminum. In one example, each of these components is constructed from the same material. Other examples include differences in the construction of two or more of the components.

FIGS. 2 and 6 illustrates a pin 50 inserted into a socket 20. In one example, the connector 70 can include a single pin 50 and socket 20 combinations. In other examples, the connector 70 includes multiple pin 50 and socket 20 combinations. The pin 50 can have a limited amount of play to be movable within an opening in a face 125. In one example, a biasing member biases the pin 50 outward from a support member 126 and through an opening in the face 125.

The pin 50 is sized to fit through the opening 22 and into the interior space 26 of the socket 20. In one example as illustrated in FIG. 2, the pin 50 is spaced away from the bottom 25. Because of this spacing, the force exerted by the biasing member 57 does not interfere with the force needed to insert the pin 50 into the socket 20.

The contact section 52 of the pin 50 contact against the inner edges 33 of the toroidal spring 30. The contact extends around the perimeter of the contact section 52. The toroidal spring 30 further contacts against the body 21 of the socket 20 to provide for the electrical connection. Current thus can pass along electrical lead 29, through the socket 20, into the pin 50, and into the electrical lead 59 to power the associated tool. The cap section 51 facilitates insertion into the toroidal spring 30 due to the shape and/or low-friction construction. Once the pin 50 is fully inserted as illustrated in FIG. 2, the cap section 51 is positioned in the interior space 26 beyond the toroidal spring 30 and is not in contact with the toroidal spring 30.

During the connection, the toroidal spring 30 contacts against the body 21 of the socket 20 in one or more points. In one example as illustrated in FIG. 2, the toroidal spring 30 contacts against each of the flange 23 and lateral side 24. In another example, the toroidal spring 30 contacts against a single section of the body 21. The toroidal spring 30 can also contact against the shelf 28 as illustrated in FIG. 4. The shelf 28 is electrically conductive and connected to the lateral side 24 to provide for the current to pass.

During the contact, the toroidal spring 30 deforms due to the force exerted by the pin 50. In one example, the coils 35 of the toroidal spring 30 include a circular sectional shape prior to insertion of the pin 50. After insertion as illustrated in FIG. 2, the coils 35 are deformed and have a non-circular sectional shape. The deformation of the toroidal spring 30 can facilitate the contact of the toroidal spring 30 with both the body 21 and the pin 50.

The pin 50 can include various shapes to facilitate the contact with the toroidal spring 30. In one example as illustrated in FIGS. 5 and 6, the pin 50 is a cylinder with a circular sectional shape. In one example, the width W of the contact section 52 is larger than the diameter D1 of the opening 32 of the toroidal spring 30. This sizing causes the toroidal spring 30 to deform and for the opening 32 to enlarge during insertion of the pin 50. In another example, the diameters of the contact section 52 and opening 22 are substantially the same.

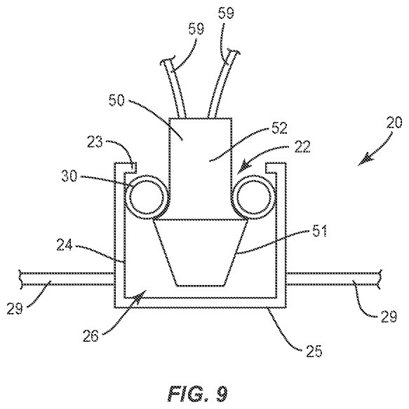

The pin 50 can include other shapes and sizes. FIG. 9 includes a pin 50 with the cap section 51 being wider than the contact section 52. The pin 50 is sized and configured for the cap section 51 to fit within the opening 22 in the socket 20 and move into the interior space 26. The toroidal spring 30 deforms during insertion of the cap section 51 and rebounds to contact against the contact section 52 to provide for the electrical connection to pass the current from the electrical lead 29 to 59. In one example, the diameter of the contact section 52 is larger than the diameter of the opening 32 to maintain the contact section 52 in contact with the toroidal spring 30.

The socket 20 and toroidal spring 30 are constructed from electrically conductive materials. Examples include but are not limited to aluminum, copper, steel, iron, and combinations thereof.

In one example, the cap section 51 is constructed from a low-friction material and the contact section 52 is constructed from a higher-friction material.

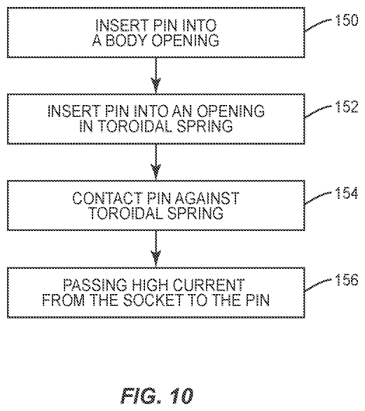

FIG. 10 illustrates a method of engaging a connector and electrically connecting a pin 50 to a socket 20 to pass high current. The pin 50 and socket 20 are aligned together. A tapered cap section 51 of the pin 50 is positioned at the socket 20. The pin 50 is inserting into the socket 20 a first amount and into a body opening 21 in the socket 50 (block 150). This includes inserting the distal cap section 51 into the body opening 21. The distal cap section 51 includes a tapered shape and facilitates aligning the pin 50 with the socket 20.

The method includes inserting the pin 50 an additional second amount into an opening 32 in a toroidal spring 30 (block 152). The toroidal spring 30 is positioned in the socket 20 and is coaxial with the body opening 22. The cap section 51 also is constructed from a low-friction material that reduces the forces required to slide the cap section 51 along the toroidal spring 30 and into the socket 20. This low-friction material reduces wear on the toroidal spring 30 and the pin 50.

The pin 50 is fully inserted into the socket 20. This positioning places a contact section 52 of the pin 50 against the toroidal spring 30 (block 154). The contact section 52 is constructed from a conductive material. This positioning also locates the cap section 51 at the distal end 53 in the interior space 26 of the socket 20. The cap section 51 is constructed from a non-conductive material and is spaced away from and not in contact with the toroidal spring 30.

With the contact section 52 of the pin 50 contacting against the toroidal spring 30, high current from the socket 20 is passed to the pin 50 (block 156).

In one example during insertion of the pin 50 into the opening 32 in the toroidal spring 30, the insertion force enlarges the toroidal spring 30. This causes the toroidal spring 30 to apply a constant contact around the entirety of the perimeter of the pin 50.

The structure of the socket 20 is tolerant to dirt and debris that can accumulate in the interior space 26. Further, the toroidal spring 30 is accessible in the body 21 and can be removed through the opening 22 and replaced with another toroidal spring 30.

FIG. 1 includes an example with connector 70 having multiple sockets 20 that mate with corresponding pins 50 in the tool assembly 120. Other examples can include different numbers of sockets 20 and pins 50 that provide for transferring high current electrical power between the master assembly 110 and tool assembly 120. One specific example includes a single socket 20 and a single pin 50.

FIG. 1 also includes an example with one or more sockets 20 on the master assembly 110 and the corresponding one or more pins 50 on the tool assembly 120. This arrangement can be reversed with the one or more sockets 20 on the tool assembly 120 and the one or more pins 50 on the master assembly 110. In one example, current is passed from the socket 20 to the pin 50. In another example, current is passed from the pin 50 to the socket 20.

The connector 70 can also be used to pass electrical signals for a wide variety of data that is communicated in both directions between the master assembly 110 to the tool assembly 120.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

For simplicity and illustrative purposes, the present invention is described by referring mainly to an exemplary embodiment thereof. Numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A socket that engages with a pin of a connector to pass high current from a robotic device to a tool, the socket comprising:
a body comprising an enclosed interior space with a central section, the body further comprising a body opening that leads into the central section of the interior space; and
a toroidal spring positioned in the interior space of the body and comprising an annular shape with a toroidal spring opening that aligns with the body opening, the toroidal spring extends around the central section, the toroidal spring comprising a helical body with a plurality of coils that each comprise an inner edge at the central section and that are exposed at the body opening and an outer edge positioned away from the central section and not exposed in the body opening.

2. The socket of claim 1, wherein the body comprises:
a bottom;
a flange that extends around the body opening; and
a lateral side that extends between the bottom and the flange.

3. The socket of claim 2, wherein the flange extends inward from the lateral side and with an inner edge of the flange defining the body opening.

4. The socket of claim 3, wherein the flange forms an overhang with the bottom, and the toroidal spring positioned in the overhang with the inner edges of the coils extending beyond the overhang and into the central section of the interior space.

5. The socket of claim 2, wherein the toroidal spring is in contact against each of the bottom, the lateral side, and the flange of the body.

6. The socket of claim 1, wherein each of the toroidal spring opening and the body opening have circular shapes.

7. The socket of claim 6, wherein the toroidal opening is coaxially aligned with the body opening.

8. The socket of claim 1, wherein a diameter of the opening of the toroidal spring is smaller than a diameter of the body opening.

9. The socket of claim 1, wherein the toroidal spring comprises a continuous helical coil comprising a plurality of coils.

10. A pin that engages with a socket of a connector to pass high current from a robotic device to a tool, the pin comprising:
a cap section positioned at a distal end of the pin;
a contact section positioned inward from the cap section along a length of the pin, the contact section is electrically conductive;
the cap section comprising a tapered shape that is narrower at the distal end and wider towards the contact section; and
the contact section comprising a fixed width.

11. The pin of claim 10, wherein the cap section is a separate piece that is connected to the contact section.

12. The pin of claim 10, wherein the cap section and the contact section are constructed from a single body and the cap section further comprises an electrically non-conductive coating on the conductive body.

13. The pin of claim 10, wherein the cap section is directly adjacent to the contact section and is electrically non-conductive.

14. The pin of claim 10, wherein each of the cap section and the contact section comprise circular sectional shapes.

15. A connector to pass high current from a robotic device to a tool, the connector comprising:
one or more pins, the pins comprising:
an elongated body with a distal end and a proximal end;
a cap section positioned at the distal end, the cap section is electrically non-conductive;
a contact section positioned along the body inward from the cap section, the contact section is electrically conductive;
one or more sockets, the sockets comprising:
a body that extends around and forms an interior space, the body further comprising a body opening that leads into the interior space;
a toroidal spring positioned in the interior space of the body and contacting against the body, the toroidal spring comprising an enclosed opening with a toroidal spring opening that aligns with the body opening, the toroidal spring comprising a helical body with a plurality of coils that each comprise an inner edge and an outer edge;
wherein the one or more pins are sized to fit within one of the sockets with the pins extending through the body opening and the toroidal spring opening and with the toroidal spring extending around and contacting against the contact section.

16. The connector of claim 15, wherein the cap section comprises a tapered shape that is narrower at the distal end and wider towards the contact section, and the contact section comprises a constant width.

17. The connector of claim 15, wherein the interior space comprises an upper flange, lateral side, and bottom, the toroidal spring positioned in the interior space and spaced away from the bottom.

18. The connector of claim 15, wherein the inner edges of the coils are exposed within the body opening and the outer edges of the coils are shielded by the body.

19. The connector of claim 15, wherein each the pin comprises a circular sectional shape and each of the toroidal spring opening and the body opening having circular shapes.

20. The connector of claim 15, wherein a diameter of the contact section of the pin is larger than a diameter of the toroidal spring opening.

21. The connector of claim 15, wherein the cap section comprises an electrically non-conductive coating.

22. The pin of claim 10, wherein the cap section of the pin is directly adjacent to the contact section.

23. A method of electrically connecting a pin to a socket to pass high current from a master assembly of a robotic device to a tool assembly, the method comprising:
inserting the pin into the socket a first amount and into a body opening in the socket;
inserting the pin into the socket an additional second amount and into an opening in a toroidal spring that is positioned in the socket and is coaxial with the body opening;
contacting the pin against the toroidal spring; and
with the pin contacting against the toroidal spring, passing high current between the socket and the pin.

24. The method of claim 23, further comprising inserting the pin into the opening in the toroidal spring and deforming the toroidal spring.

25. The method of claim 23, further comprising contacting the toroidal spring against a body of the socket while the pin is contacting against the toroidal spring and passing the high current through the body and into the toroidal spring.

26. The method of claim 23, further comprising inserting the pin into the opening in the toroidal spring and expanding a diameter of the opening.

27. The method of claim 23, wherein contacting the pin against the toroidal spring comprises contacting the toroidal spring completely around a perimeter of the pin.

28. The method of claim 23, further comprising inserting the pin into the opening in the toroidal spring and forcing an outer edge of the toroidal spring against a lateral side of the socket.

29. The method of claim 23, further comprising contacting a conductive contact section of the pin against the toroidal spring and positioning a non-conductive cap section of the pin in the socket and away from the toroidal spring.

30. The method of claim 23, further comprising contacting a non-conductive tapered section of the pin against the toroidal spring prior to contacting a conductive section of the pin against the toroidal spring.

31. The method of claim 23, further comprising spacing a distal end of the pin away from the bottom of the socket when a conductive contact section of the pin contacts against the toroidal spring.
